(19) United States
(12) Patent Application Publication
(10) Pub. No.: US 2024/0119465 A1
(43) Pub. Date: Apr. 11, 2024

(54) AUTHENTICATIONS OF CONSUMABLES BASED ON AUTHENTICATION INDICIA

(71) Applicant: Hewlett-Packard Development Company, L.P., Spring, TX (US)

(72) Inventors: Gabriel Scott McDaniel, Boise, ID (US); Paul L. Jeran, Boise, ID (US); Jeffrey Harold Luke, Boise, ID (US)

(73) Assignee: Hewlett-Packard Development Company, L.P., Spring, TX (US)

(21) Appl. No.: 18/553,967

(22) PCT Filed: Apr. 13, 2021
(86) PCT No.: PCT/US2021/027005

§ 371 Date: Oct. 4, 2023

(51) Int. Cl. G06Q 30/018; G06K 7/14

(52) U.S. Cl. CPC G06Q 30/018; G06K 7/1413; G06K 7/1417

(57) ABSTRACT

A device receives information regarding whether a cover of an authentication indicia of a consumable has been subject to tampering. In response to the information indicating that the cover of the authentication indicia has not been subject to tampering, the device obtains an image of the authentication indicia after the cover has been removed from the authentication indicia. The device performs an authentication process to authenticate the consumable based on the authentication indicia.

### BACKGROUND

A printing device can deliver a print material to a print medium to form an image on the print medium. In some examples, a printing device can be an electrophotographic printing device that supplies a toner (which is a type of print material) to an electrostatic latent image formed on a photoconductor to form a visible toner image on the photoconductor. The electrophotographic printing device transfers the toner image to a print medium, and then fixes the transferred toner image to the print medium, to form an image on the print medium.

In other examples, other types of printing devices can employ other types of print materials. For example, a printing device can employ ink that is ejected onto a print medium to form an image on the print medium. In further examples, a printing device can be a three-dimensional (3D) printing device, also referred to as an additive manufacturing machine that builds 3D objects on a layer-by-layer basis. In processing each layer of build material used in forming a 3D object, the 3D printing device can supply a liquid print agent to the layer. The liquid print agent is a form of print material.

### BRIEF DESCRIPTION OF THE DRAWINGS

Some implementations of the present disclosure are described with respect to the following figures.

FIG. 1 is a block diagram of an arrangement including a user device, a server, and a consumable to be authenticated, according to some examples.

FIG. 2 is a flow diagram of a process of a user device and a server, according to some examples.

FIG. 3 illustrates a print material refill container with an authentication indicia, according to some examples.

FIG. 4 is a block diagram of a storage medium storing machine-readable instructions according to some examples.

FIG. 5 is a block diagram of a server according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A “consumable” is an item for use in a machine, where the consumable contains a material or property that is consumed during operation of the machine. For example, a consumable can include a print cartridge containing a print material, where the print cartridge can be installed in a printing device for delivery of the print material during a print operation. As another example, a consumable can include a print material refill container that contains a print material for refilling a reservoir in a printing device. In a further example, a consumable can include a battery that contains a charge to provide power in an electronic device during operation of the electronic device. Other examples of consumables can be used with other types of machines, such as vehicles, medical devices, and so forth.

A machine (e.g., a printing device, an electronic device, etc.) may be designed for use with consumables having specific target characteristics. Consumables may be made by the manufacturer of the machines in which the consumables are to be used. Alternatively or additionally, consumables may be made by third parties authorized by the manufacturer of the machines.

In some cases, unauthorized third parties may attempt to market consumables for use with machines. Consumables made by such unauthorized third parties may not work properly with the machines or may cause the machines to produce sub-optimal results. In some cases, consumables may be counterfeits that are marketed as being made by a certain manufacturer or an authorized third party when in fact the consumables were made by a different source.

Makers of consumables may include authentication mechanisms in the consumables to allow the consumables to be authenticated prior to use. Authenticating a consumable can refer to verifying that the consumable is from an authorized source and/or has not been compromised or modified in an unauthorized or unintended manner. In some examples, memory devices may be included in consumables. A memory device in a consumable can store information that can be used by a machine to authenticate the consumable prior to use of the consumable with the machine.

Adding memory devices in consumables for the purpose of authenticating the consumables may increase to the cost of the consumables. In some cases, a consumable may not include a memory device, or may have a memory device that has a restricted storage capacity such that authentication information cannot be stored in the memory device.

In accordance with some implementations of the present disclosure, authentication indicia in a non-electronic form can be provided with a consumable. For example, the consumable may have a housing with an outer surface, and the authentication indicia may be provided on the outer surface of the housing. In some examples, the authentication indicia can include a barcode, a quick response (QR) code, or any other type of authentication indicia. An authentication indicia contains or encodes information that may be used for authenticating the consumable.

To avoid unauthorized access of an authentication indicia on a consumable (e.g., to prevent an unauthorized person or other entity from viewing the authentication indicia), a cover can overlay the authentication indicia such that the authentication indicia cannot be read. The cover can overlay the entirety of the authentication indicia or a part of the authentication indicia. In some examples, the cover is a scratch-off layer that can be scratched off using an object, such as a user's fingernail, a coin, or another type of object. In other examples, the cover can be in the form of a removable flap that is removably adhered to the authentication indicia. Once a user peels back the removable flap to uncover the authentication indicia, the removable flap may be torn and cannot again be adhered to the authentication indicia. More generally, the cover is a one-time use cover that when manipulated to uncover an authentication indicia cannot again be used to cover the authentication indicia.

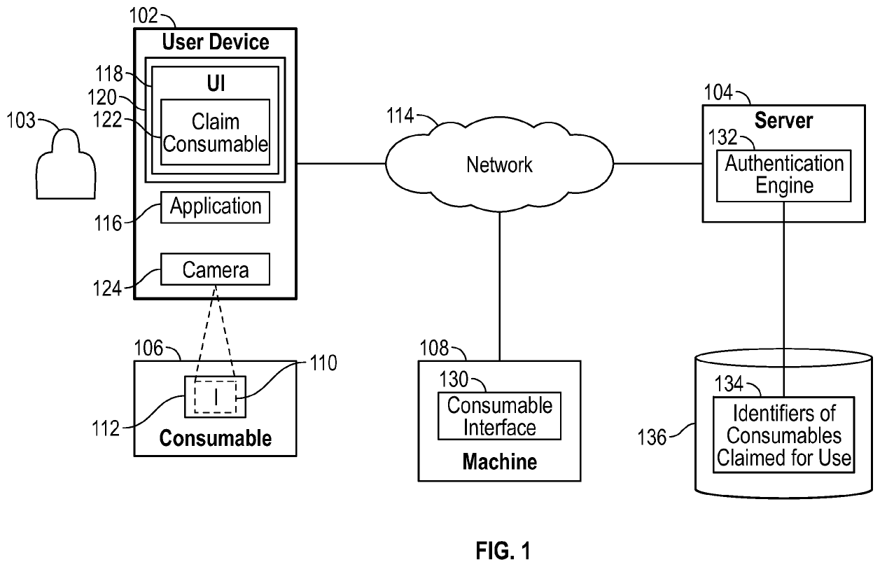

FIG. 1 illustrates an example arrangement for performing authentication of a consumable 106 according to some examples. Multiple entities can be involved in the authentication process according to some examples. The entities include a user device 102 (which can be used by a user 103), a server 104, and the consumable 106.

The user device 102 can include any type of electronic device. Examples of the user device 102 can include any or some combination of the following: a smartphone, a tablet computer, a notebook computer, a desktop computer, a computer in a vehicle, a household appliance, a game appliance, or any other type of electronic device.

The server 104 can include a computer or an arrangement of computers. For example, the server 104 can include a web server, a cloud server, an application server, or any other arrangement of computer(s).

The consumable 106 is for use in a machine 108, where the machine 108 can include a printing device, an electronic device, or any other type of machine. The consumable 106 includes an authentication indicia 110 provided on a surface of an outer housing of the consumable 106. Initially and prior to use of the consumable 106, the authentication indicia 110 can be covered (either partially or entirely) by a cover 112. For example, the authentication indicia 110 can be printed (e.g., by laser etching) onto the surface of the outer housing of the consumable 106, or the authentication indicia 110 can be adhered to or affixed to the surface of the outer housing of the consumable 106, or the authentication indicia 110 can be provided on the surface of the outer housing of the consumable 106 by another technique.

The user 103 may have obtained the consumable 106, such as by purchasing the consumable 106 online or obtaining the consumable 106 from another source. Before the user 103 can use the consumable 106 in the machine 108, the user 103 can initiate an authentication process. In some examples, the consumable 106 may not be usable in the machine 108 prior to authentication of the consumable 106. For example, the machine 108 may be in communication with the server 104 over a network 114 (e.g., a wired network and/or a wireless network). The machine 108 may wait for the server 104 to authorize use of the consumable 106 before the machine 108 will accept the consumable 106 for use. Alternatively, the user device 102 may provide an indication to the machine 108 that the consumable 106 has been authenticated.

The user device 102 can be in communication with the server 104 and/or the machine 108 over the network 114.

The machine 108 includes a consumable interface 130 to receive the consumable 106. For example, if the consumable 106 is a print cartridge and the machine 108 is a printing device, the consumable interface 130 can include a port through which a print material in the print cartridge can be dispensed into the machine 108 for use. As another examples, if the consumable 106 is a print material refill container, the consumable interface 130 of the machine 108 includes a mechanism to which the print material refill container can connect to refill a reservoir in the machine 108 with the print material in the print material refill container.

The user 103 may use the user device 102 to initiate authentication of the consumable 106. For example, the user device 102 can include an application program 116 that when launched, such as in response to user activation, starts the authentication process. The application program 116 may be provided by the maker or other supplier of the consumable 106, or by a different entity. The user 103 can download the application program 116 to the user device 102.

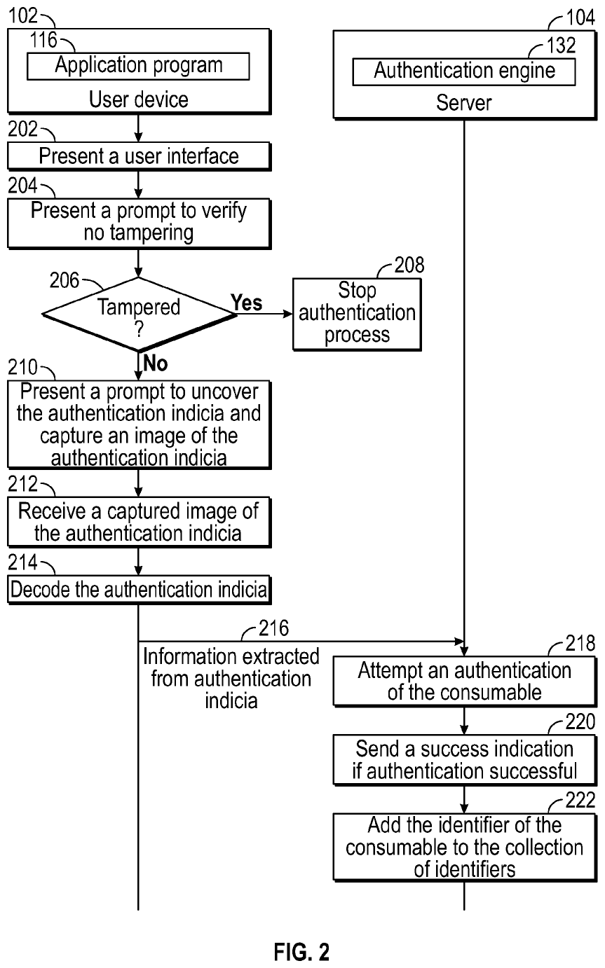

The follow refers to both FIGS. 1 and 2. FIG. 2 is an authentication process for the consumable 106, according to some examples. When launched, the application program 116 presents (at 202) a user interface 118, such as in a display device 120 (e.g., a touch-sensitive display device) of the user device 102. The user interface 118 includes a user-activable element 122 that when activated by the user 103 (e.g., such as based on a touch on the touch-sensitive the display 120 or by using an input device such as a keyboard, a mouse, or a touchpad) provides an indication that the user 103 wishes to claim the consumable 106 for use

The request to claim the consumable 106 for use initiates the authentication process.

As part of the authentication process, the application program 116 can present (at 204) a prompt for the user 103 to verify that the cover 112 of the authentication indicia 110 on the consumable 106 has not been subject to tampering. The prompt may direct the user 103 to visually inspect the cover 112 or an area of the outer surface of the housing of the consumable 106 where the cover 112 and the authentication indicia 110 are supposed to be. The user 103 can enter information, such as into the user interface 118, indicating whether or not the cover 112 has been subject to tampering. For example, the user can enter the information into a text box in the user interface 118, based on selecting an item of a drop-down menu, based on selecting a user-selectable radio button, and so forth.

In alternative examples, instead of relying on a user to input an indication of whether or not the cover 112 has been subject to tampering, the application program 116 can perform an analysis of an image of the cover 112 to determine whether or not the cover 112 has been subject to tampering.

If the application program 116 determines (at 206) that the cover 112 has been tampered with (such as based on the received user-input information or the analysis of the application program 116), then the application program 116 can stop (at 208) the authentication process, and present an alert in the user interface 118 indicating that use of the consumable 106 is prohibited.

If the application program 116 determines (at 206) that the cover 112 has not been subject to tampering, the application program 116 can proceed with the authentication process. The application program 116 may present (at 210) a prompt to the user 103 to uncover the cover 112, such as scratching off the cover 112 or peeling back the cover 112, and to use a camera 124 of the user device 102 for capturing an image of the authentication indicia 110 after uncovering the authentication indicia 110.

If the camera 124 is activated by the user 103 to capture the authentication indicia 110 on the consumable 106, the application program 116 receives (at 212) the captured image of the authentication indicia 110. The application program 116 can decode (at 214) the authentication indicia 110 to extract information relating to the consumable 106. For example, the authentication indicia 110 can include a barcode or a QR code that can be decoded by the application program 116.

If the user device 102 is online and connected to the server 104 over the network 114, the application program 116 can send (at 216), to the server 104, information extracted based on the authentication indicia 110.

In some examples, the information extracted based on the captured authentication indicia 110 and sent by the application program 116 to the server 104 can include any or some combination of the following pieces of information: a digital signature, an identifier of the consumable 106 (e.g., a universally unique identifier (UUID) or another type of identifier), and other information. Examples of other information that can be included includes an identifier of a manufacturer of the consumable 106, a country of origin of the consumable 106, a manufacturing date of consumable 106, and so forth.

The digital signature included in the information can be created by signing information associated with the consumable 106 (e.g., an identifier of the consumable 106 and/or other information) using a private key, which can be associated with the manufacturer or other supplier of the consumable 106. The private key can be part of a public-private key pair that further includes a public key. The public key can be provided to the server 104, which can decrypt the digital signature using the public key.

In response to the information from the application program 116, an authentication engine 132 in the server 104 can attempt (at 218) an authentication of the consumable 106.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

If the authentication engine 132 is able to successfully decrypt the digital signature, then that provides an indication that the source of the digital signature is authorized and thus the consumable 106 is authentic. As part of the authentication of the consumable 106, the authentication engine 132 can further check if the consumable 106 has been previously claimed for use. For example, the authentication engine 132 can compare the identifier of the consumable 106 received from the application program 116 with a collection 134 of identifiers of consumables that have been claimed for use. The collection 134 of identifiers can be stored in a repository 136, which can be implemented using a storage device (or multiple storage devices).

If the identifier of the consumable 106 matches any identifier in the collection 134 of identifiers, then that indicates that the consumable 106 was previously claimed for use. In this case, the authentication engine 132 can indicate that the consumable is not authenticated.

In the foregoing examples, the authentication engine 132 can indicate that the consumable 106 is authentic if the authentication engine 132 is able to successfully decrypt the digital signature, and confirms that the consumable 106 was not previously claimed for use. In other examples, the authentication engine 132 can authenticate the consumable 106 using additional or alternative procedures.

Assuming that the authentication engine 132 is able to successfully authenticate the consumable 106 based on information (e.g., the digital signature and the identifier of the consumable 106) from the application program 116, the authentication engine 132 can send (at 220) a success authentication indication to the user device 102 that the consumable 106 has been successfully authenticated. The application program 116 can issue a notification, such as in the user interface 118 of FIG. 1, that the consumable 106 has been successfully authenticated.

In some examples, if the authentication engine 132 is able to successfully authenticate the consumable 106, the authentication engine 132 can send the success authentication indication to the machine 108 to accept use of the consumable 106. Alternatively, the user device 102 can send the success authentication indication to the machine 108. For example, if the consumable 106 is a print material cartridge or a print material refill container, the machine 108 can activate the consumable interface 130 (such as actuating a valve of a port to receive a print material, or another mechanism) to accept a print material from the consumable 106.

On the other hand, if the authentication engine 132 is unable to successfully authenticate the consumable 106, the authentication engine 132 does not send the success authentication indication or sends an authentication reject indication to the user device 102. In this latter case, the application program 116 can issue a notification, such as in the user interface 118 of FIG. 1, that the consumable 106 has not been successfully authenticated.

If the machine 108 receives an indication (from the authentication engine 132 or from the user device 102) that the consumable 106 is not authenticated, then the machine 108 can prevent use of the consumable 106 in the machine 108 (such as by keeping a port of the consumable interface 130 closed to prevent input flow of a print material from the consumable 106).

In addition, assuming that the authentication engine 132 has successfully authenticated the consumable 106, the authentication engine 132 can add (at 222) the identifier of the consumable 106 to the collection 134 of identifiers, which can mark the consumable 106 as claimed for use. In this way, once the consumable 106 has been claimed for use once, the consumable 106 cannot be re-used again and the authentication engine 132 can reject a subsequent attempt at authenticating the same consumable 106.

In the authentication process discussed above, it is assumed that the user device 102 is connected over the network 114 to the server 104. In other examples, an offline authentication process can be performed in scenarios where the user device 102 is not connected over the network 114 to the server 104, such as when the user device 102 is in a location without network connectivity, or when network connectivity has been temporarily lost.

The offline authentication process can include similar tasks as tasks 202 to 214 shown in FIG. 2, except that the user device 102 is unable to send to the server 104 information extracted based on the captured authentication indicia 110 while the user device 102 is offline with respect to the server 104. The user device 102 may be provided with a list of identifiers of unauthorized consumables and/or a list of identifiers of authorized consumables. In this case, the application program 116 in the user device 102 can check the identifier of the consumable 106 with the list of identifiers of unauthorized consumables and/or the list of identifiers of authorized consumables. If the identifier of the consumable matches any identifier in the list of identifiers of unauthorized consumables, then the offline authentication process of the application program 116 may reject the consumable 106, and can provide a notification to the machine 108 that the consumable 106 has not been authenticated.

On the other hand, if the identifier of the consumable matches any identifier in the list of identifiers of authorized consumables, then the offline authentication process of the application program 116 may accept the consumable 106, and can provide a notification to the machine 108 that the consumable 106 has been authenticated. If the identifier does not match either of the list of identifiers of unauthorized consumables or the list of identifiers of authorized consumables, then the offline authentication process may be inconclusive, and can wait for re-establishment of a network connectivity with the server 104 to complete the authentication process of FIG. 2.

Assuming that the consumable 106 was authenticated or rejected (such as based on the list of identifiers of unauthorized consumables and/or the list of identifiers of authorized consumables), the application program 116 can, after the device establishes a connection with the server 104, provide, to the server 104 over the network 114, information (e.g., including the digital signature and the identifier of the consumable 106) of the authentication process that has been performed offline.

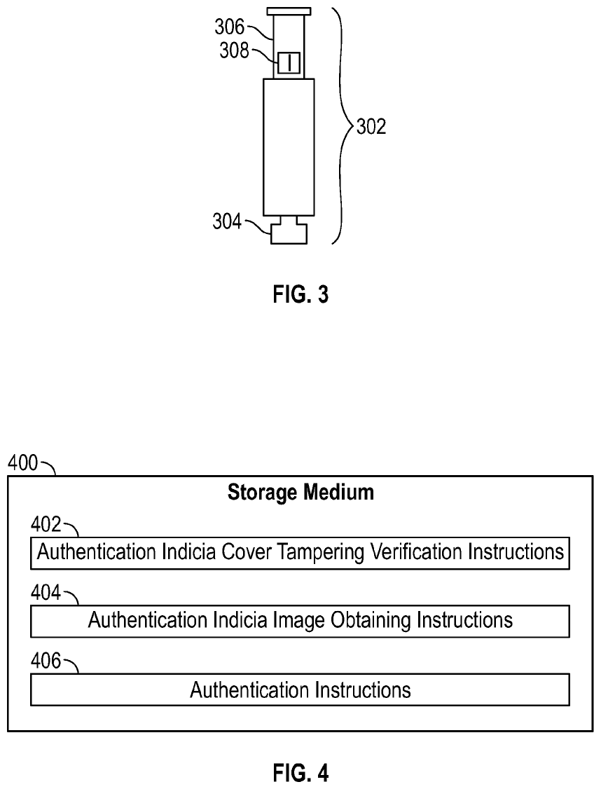

In some examples, the authentication indicia 110 can be obscured once the consumable 106 is actually used. FIG. 3 illustrates an example print material refill container 302, which is an example of the consumable 106. The print material refill container 302 includes an internal chamber that contains a print material that is to be supplied to a print material reservoir of a printing device. The print material refill container 302 has an engagement mechanism 304 to engage a refill interface of a printing device. Once the engagement mechanism 304 is engaged with the printing device, actuation of the print material refill container 302 can cause dispensing of the print material in the print material refill container 302 to a print material reservoir of the printing device.

In some examples, actuation of the print material refill container 302 can be accomplished by depressing a plunger 306 of the print material refill container 302. In other examples, actuation of the print material refill container 302 can be accomplished by performing a different translation or a rotation of the plunger 306, or by actuation of another activation mechanism. In the example shown in FIG. 3, the plunger 306 can be actuated downwardly to cause the print material in the print material refill container 302 to be dispensed out of the print material refill container 302. In some examples, once the plunger 306 is moved downwardly to actuate the print material refill container 302, the plunger 306 is locked in place and does not rise back up.

In some examples, an authentication indicia 308 (similar to the authentication indicia 110 of FIG. 1) is provided on an outer surface of the plunger 306. In some examples, the authentication indicia 308 is provided on a lower part of the plunger 306. As a result, when the plunger 306 is actuated downwardly and locked in a down position, the authentication indicia 308 is hidden from view such that the authentication indicia 308 can no longer be read for another authentication process. This prevents the print material refill container 302 from being reused, since the hidden authentication indicia 308 cannot be read again.

In other examples, instead of hiding the authentication indicia after use, an authentication indicia can be obscured by providing a marking over the authentication indicia, damaging the authentication indicia such that it is no longer machine-readable, and so forth.

FIG. 4 is a block diagram of a non-transitory machine-readable or computer-readable storage medium 400 storing machine-readable instructions that upon execution cause a device (e.g., the user device 102) to perform specified tasks. The machine-readable instructions can be part of the application program 116 of FIG. 1, for example.

The machine-readable instructions include authentication indicia cover tampering verification instructions 402 to receive information regarding whether a cover of an authentication indicia of a consumable has been subject to tampering. The received information may have been input by a user, or can be based on automated analysis of an image that includes a region where the authentication indicia and cover are supposed to be.

The machine-readable instructions include authentication indicia image obtaining instructions 404 to, in response to the information indicating that the cover of the authentication indicia has not been subject to tampering, obtain an image of the authentication indicia after the cover has been removed from the authentication indicia. The image of the authentication indicia can be obtained based on prompting a user to uncover the authentication indicia (e.g., by removing the cover 112 in FIG. 1) and activate a camera of a user device to capture the image of the uncovered authentication indicia.

The machine-readable instructions include authentication instructions 406 to perform an authentication process to authenticate the consumable based on the authentication indicia. In some examples, the performing of the authentication process includes sending, over a network to a server (e.g. the server 104 of FIG. 1), information based on the authentication indicia, and receiving, over the network from the server, an indication that the consumable is authentic.

In some examples, the machine-readable instructions can send, over the network to the server, claiming information indicating that a user of the device is claiming use of the consumable. In some examples, the claiming information is in the form of an identifier of the consumable, which can be added by the server to a collection (e.g., 124 in FIG. 1) of identifiers of consumables that have been claimed for use. Consumables can be used just once, such that any consumable identified in the collection of identifiers cannot be authenticated for use again.

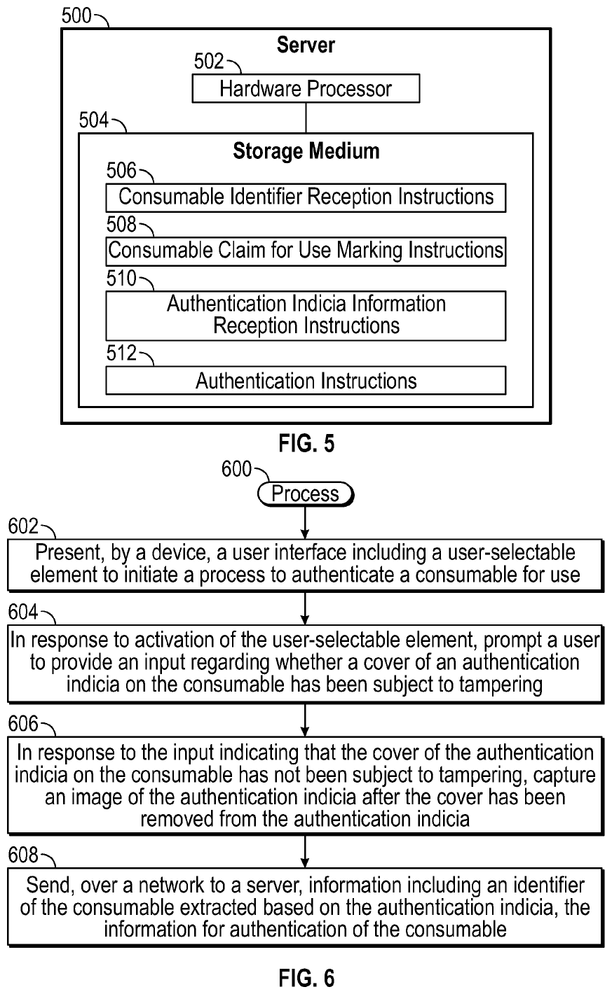

FIG. 5 is a block diagram of a server 500, which is an example of the server 104 of FIG. 1. The server 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The server 500 includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include consumable identifier reception instructions 506 to receive, over a network from a device (e.g., the user device 102 of FIG. 1), an identifier of a consumable.

The machine-readable instructions in the storage medium 504 include consumable claim for use marking instructions 508 to mark the consumable as claimed for use. This can be accomplished by adding an identifier of the consumable to a collection of identifiers of consumables that have been claimed for use (e.g., collection 134 in FIG. 1).

The machine-readable instructions in the storage medium 504 include authentication indicia information reception instructions 510 to receive, over the network from the device, information of an authentication indicia on the consumable. The authentication indicia can be captured by a camera of the device after a cover of the authentication indicia has been removed from the authentication indicia.

The machine-readable instructions in the storage medium 504 include authentication instructions 512 to perform an authentication process to authenticate the consumable based on the authentication indicia. In some examples, the authentication process further based on checking whether the identifier of the consumable was previously claimed for use. The authentication process can decline to authenticate the consumable in response to detecting that the identifier of the consumable was previously claimed for use.

FIG. 6 is a flow diagram of a process 600 according to some examples of the present disclosure. The process 600 includes presenting (at 602), by a device, a user interface (e.g., 118 in FIG. 1) including a user-selectable element (e.g., 122 in FIG. 1) to initiate a process to authenticate a consumable for use.

In response to activation of the user-selectable element, the device prompts (at 604) a user to provide an input regarding whether a cover of an authentication indicia on the consumable has been subject to tampering.

In response to the input indicating that the cover of the authentication indicia on the consumable has not been subject to tampering, the device captures (at 606) an image of the authentication indicia after the cover has been removed from the authentication indicia.

The device sends (at 608), over a network to a server, information including an identifier of the consumable extracted based on the authentication indicia, the information for authentication of the consumable.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A non-transitory machine-readable storage medium comprising instructions that upon execution cause a device to:
receive information regarding whether a cover of an authentication indicia of a consumable has been subject to tampering;
in response to the information indicating that the cover of the authentication indicia has not been subject to tampering, obtain an image of the authentication indicia after the cover has been removed from the authentication indicia; and
perform an authentication process to authenticate the consumable based on the authentication indicia.

2. The non-transitory machine-readable storage medium of claim 1, wherein the performing of the authentication process comprises:
sending, over a network to a server, information based on the authentication indicia, and
receiving, over the network from the server, an indication that the consumable is authentic.

3. The non-transitory machine-readable storage medium of claim 2, wherein the instructions upon execution cause the device to:
send, over the network to the server, claiming information indicating that a user of the device is claiming use of the consumable.

4. The non-transitory machine-readable storage medium of claim 1, wherein the instructions upon execution cause the device to:
in response to the information indicating that the cover of the authentication indicia has been subject to tampering, stop the authentication process of the consumable.

5. The non-transitory machine-readable storage medium of claim 1, wherein the instructions upon execution cause the device to:
present a prompt seeking an input regarding whether the cover of the authentication indicia has been subject to tampering,
wherein the information is responsive to the prompt.

6. The non-transitory machine-readable storage medium of claim 1, wherein the instructions upon execution cause the device to:
perform the receiving of the information, the obtaining of the image, and the performing of the authentication process while the device is offline from a server.

7. The non-transitory machine-readable storage medium of claim 6, wherein the instructions upon execution cause the device to:
after the device establishes a connection with the server following the performing of the authentication process, provide, to the server over a network, information of the authentication process that has been performed offline.

8. A server comprising:
a processor; and
a non-transitory storage medium storing instructions executable on the processor to:
receive, over a network from a device, an identifier of a consumable;
mark the consumable as claimed for use;
receive, over the network from the device, information of an authentication indicia on the consumable, the authentication indicia captured by a camera of the device after a cover of the authentication indicia has been removed from the authentication indicia; and
perform an authentication process to authenticate the consumable based on the authentication indicia.

9. The server of claim 8, wherein the instructions are executable on the processor to perform the authentication process further based on checking whether the identifier of the consumable was previously claimed for use.

10. The server of claim 8, wherein the instructions are executable on the processor to decline to authenticate the consumable in response to detecting that the identifier of the consumable was previously claimed for use.

11. The server of claim 8, wherein the information of the authentication indicia comprises a digital signature, and wherein instructions are executable on the processor to:
verify the digital signature using a key.

12. A method comprising:
presenting, by a device, a user interface comprising a user-selectable element to initiate a process to authenticate a consumable for use;
in response to activation of the user-selectable element, prompting, by the device, a user to provide an input regarding whether a cover of an authentication indicia on the consumable has been subject to tampering;
in response to the input indicating that the cover of the authentication indicia on the consumable has not been subject to tampering, capturing, by the device, an image of the authentication indicia after the cover has been removed from the authentication indicia; and
sending, by the device over a network to a server, information comprising an identifier of the consumable extracted based on the authentication indicia, the information for authentication of the consumable.

13. The method of claim 12, wherein the authentication indicia is hidden or rendered unreadable upon use of the consumable in a machine.

14. The method of claim 12, wherein the cover of the authentication indicia comprises a scratch-off cover or a removable flap.

15. The method of claim 12, wherein the presenting, the prompting, the capturing, and the sending are performed by an application program executed in the device responsive to launching of the application program.
